(19) United States
(12) Patent Application Publication
(10) Pub. No.: US 2025/0243796 A1
(43) Pub. Date: Jul. 31, 2025

(54) CONTROLLING NOISE ON SAFETY VALVES

(71) Applicants: Stephen Temple Satterlee, Spring, TX (US); Rajesh Krithivasan, Jacksonvijlle, FL (US); Richard John Klimas, JR., Orange Park, FL (US)

(72) Inventors: Stephen Temple Satterlee, Spring, TX (US); Rajesh Krithivasan, Jacksonvijlle, FL (US); Richard John Klimas, JR., Orange Park, FL (US)

(21) Appl. No.: 18/423,655

(22) Filed: Jan. 26, 2024

(51) Int. Cl. F01N 13/00; F16K 17/04

(52) U.S. Cl. CPC F01N 13/007; F16K 17/0433

(57) ABSTRACT

A silencer configured for use with a pressure relief valve. These configurations incorporate flow-reducing or disrupting features that can reduce or suppress noise in high-velocity fluid streams. These features may adopt geometry with shapes that interpose within the high-velocity flow to cause changes in flow patterns that exit the device. These patterns may create intermediate layers of slower-moving fluid about the high-velocity fluid stream. These intermediate layers suppress sound waves that are typical of aerodynamic noise. The embodiments may adopt designs that fit onto the pressure relief valves, or other flow controls, within certain confines or pre-determined envelopes that operators have for equipment within their distribution networks. In power plants, and other facilities, that flow high-velocity steam (or gas or fluids generally), the device can suppress or abate noise without the need for large, complex mufflers.

### BACKGROUND

“Fail-safe” devices protect against rapid increases in pressure. Also known as “safety” valves, or “pressure relief” valves, these devices are necessary to avoid “overpressure” conditions that can cause damage to equipment or parts of facilities. It is common for safety valves to generate significant noise in service when in use with fluids that escape the device at very high velocity. This can result in aerodynamic noise that may reach upwards of 140 dBA or, at least, exceed set limits that are necessary to provide a safe working environment for technicians and other workers at the facility.

### SUMMARY

The subject matter of this disclosure relates to improvements to safety valves to attenuate this noise to safe, acceptable levels. Of particular interest are embodiments that can modify flow of high-velocity fluids, like steam jets, that exhaust from the device. The embodiments may locate flow-dissipating elements in the flow. These elements may have geometry or other characteristics that can effect changes in the flow to effectively suppress aerodynamic noise.

### DRAWINGS

This specification refers to the following drawings:

FIG. 1 depicts a schematic diagram of an exemplary embodiment of a silencer, shown in position on a safety valve;

FIG. 2 depicts a schematic diagram of an example of the silencer of FIG. 1;

FIG. 3 depicts a perspective view from the front of an example of the silencer of FIGS. 1 and 2;

FIG. 4 depicts an elevation view from the side of the silencer of FIG. 3;

FIG. 5 depicts an elevation view of the cross-section of the silencer of FIG. 3;

FIG. 6 depicts a perspective view from the back of another example of the silencer of FIGS. 1 and 2;

FIG. 7 depicts an elevation view of the cross-section from the back of the silencer of FIG. 6;

FIG. 8 depicts an elevation view of the cross-section from the side of the silencer of FIG. 6;

FIG. 9 depicts a perspective view from the back of another example of the silencer of FIGS. 1 and 2;

FIG. 10 depicts an elevation view of the cross-section from the side of the silencer of FIG. 9;

FIG. 11 depicts an elevation view of the cross-section from the side of the silencer of FIG. 9;

FIG. 12 depicts a perspective view from the back of another example of the silencer of FIGS. 1 and 2;

FIG. 13 depicts an elevation view of the back of the silencer of FIG. 12;

FIG. 14 depicts an elevation view of the cross-section from the side of the silencer of FIG. 12; and

FIG. 15 depicts a perspective view of an example of a safety valve.

These drawings and any description herein represent examples that may disclose or explain the invention. The examples include the best mode and enable any person skilled in the art to practice the invention, including making and using any devices or systems and performing any incorporated methods. The drawings are not to scale unless the discussion indicates otherwise. Elements in the examples may appear in one or more of the several views or in combinations of the several views. The drawings may use like reference characters to designate identical or corresponding elements. Methods are exemplary only and may be modified by, for example, reordering, adding, removing, and/or altering individual steps or stages. The specification may identify such stages, as well as any parts, components, elements, or functions, in the singular with the word “a” or “an;” however, does not exclude plural of any such designation, unless the specification explicitly recites or explains such exclusion. Further, any references to “one embodiment” or “one implementation” does not exclude the existence of additional embodiments or implementations that also incorporate the recited features.

### DESCRIPTION

The discussion now turns to describe features of the examples shown in the drawings noted above. These features foreclose the need for large, unwieldy “mufflers” that manufacturers may provide to operators as means to limit excessive noise. The mufflers often house complex systems of baffles, chambers, or perforated “silencers” within “refrigerator-sized” devices. The systems tend to expand the working envelope of the safety valve within the operator's facility many times over. On the other hand, this disclosure proposes designs that are a fraction of the size of these mufflers. The designs may leverage elements that can effect changes in the flow of high-velocity fluid jets to reduce or suppress noise. Other embodiments are within the scope of this disclosure.

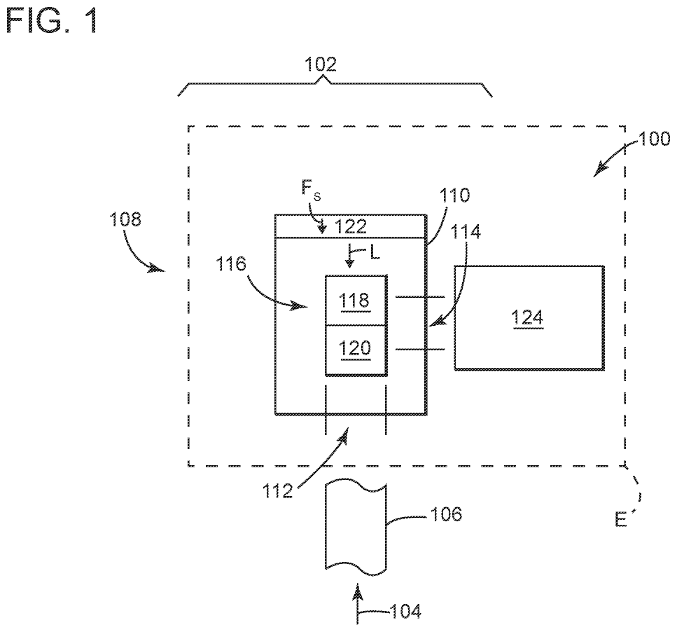

FIG. 1 depicts a schematic diagram of an exemplary embodiment of a silencer 100. This embodiment is part of a distribution network 102, typically designed to carry material 104 through a network of conduit 106. In one implementation, the silencer 100 may couple with a safety valve 108 that may integrate into the network 102. The safety valve 108 may comprise a valve body 110 with an inlet 112 and an outlet 114. Valve mechanics 116 may reside in the valve body 110 to regulate flow of material 104 from the outlet 114. The valve mechanics 116 may include a closure member 118 and a seat 120. A pre-load unit 122 may generate a load L on the closure member 118. As shown, the silencer 100 may include an airflow disrupting device 124 that couples to the outlet 114.

Broadly, the silencer 100 may be configured to abate or suppress noise. These configurations may embody devices that operate on high-velocity flow, for example, high-velocity steam or steam jets that may prevail in power plants or like industrial facilities. The devices may adopt geometry that can affect changes in flow to reduce or abate noise to safe levels (for example, less than 100 dBA) for workers and technicians that work in these facilities. The resulting designs may fit within a working envelope E that is much smaller than other “mufflers” that require more complex construction. This feature is beneficial because operators can adopt the silencer 100 without any compromise to layout restrictions in their facilities.

The distribution system 102 may be configured to deliver or move these fluids. These configurations may embody vast infrastructure. Material 104 may comprise gases, liquids, solid-liquid mixes, or liquid-gas mixes, as well. The conduit 106 may include pipes or pipelines that often connect to pumps, boilers, and the like. The pipes 106 may also connect to tanks or reservoirs. In many facilities, this equipment forms complex networks to execute a process, like refining raw materials or manufacturing a product.

The safety valve 108 may be configured to protect against overpressure conditions in these networks. These configurations may find use in thermal-hydraulic power plants, like nuclear facilities, that flow cooling water and steam at very high pressures to dissipate temperature of boilers or reactors. This disclosure does contemplate, however, that the concepts herein may apply to similar situated devices and systems that handle liquids across a range of pressure, temperature, or other operating conditions. The valve body 110 in such devices is often made of cast or machined metals. This structure may form a flange at the openings 112, 114. Adjacent pipes 106 may connect to the flange to allow material 104 to flow through the device. Typically, the valve mechanics 116 may default to a closed position with the closure member 118 in contact with the seat 120. Suitable construction of components 118, 120 creates a metal-to-metal seal. This feature may allow the safety valve 108 to operate under extreme temperatures or pressure, as well with caustic or hazardous materials.

The pre-load unit 122 may be configured to maintain the metal-to-metal seal even under high pressure downstream of the closure member 118. These configurations may compress a spring (or like resilient member) by an amount that generates a spring force F_{S} necessary to achieve load L to maintain the safety valve 108 in its closed position and prevent flow of material through the seat 120. Pressure downstream of the closure member 118 that exceeds the load L may compress the compression spring to cause the closure member 118 to move away from the seat 120. Material 104 will flow through the seat 120 in this open position and exhaust from the outlet 114. The safety valve 100 remains open until pressure downstream of the closure member 118 falls below the load L, allowing the spring to return to its previous closed position.

The airflow disrupting device 124 may be configured to intercept the flow that exhausts from the outlet 114. These configurations may embody devices that can impact flow dynamics to suppress noise. The devices may incorporate features that obstruct or deflect flow, for example, to change direction of all or part of flow. Additive manufacturing techniques (like “3D printing”) may find use to expand the breadth of geometry available for the design, as well. It may prove useful to provide features with angles, curves, shapes, bends, or other shapes (and combinations of shapes), for example, that may modify flow patterns or conditions to achieve acceptable noise levels in service. The airflow disrupting device 124, including its features discussed herein, may result from these additive manufacturing techniques. In one implementation, these features may form integrally or monolithically with other parts of the silencer 100 to form a single, unitary part.

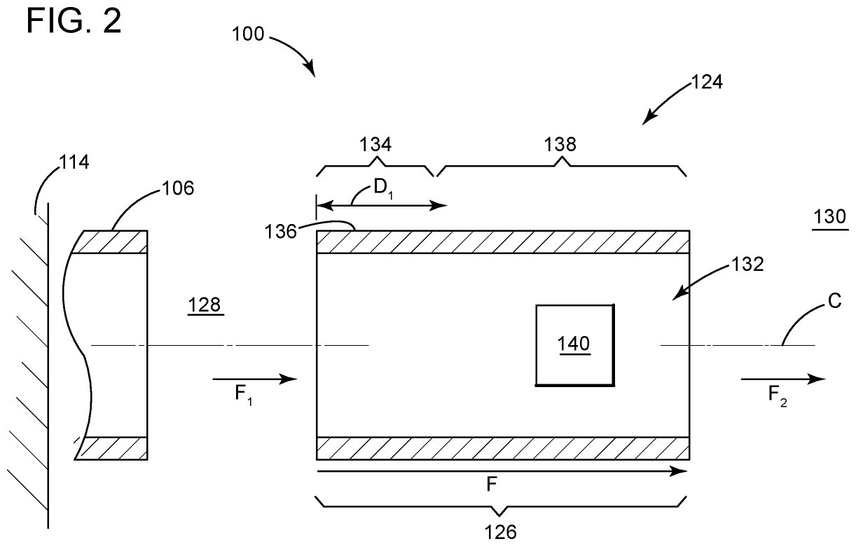

FIG. 2 depicts a schematic diagram of an example of the silencer 100 of FIG. 1. The airflow disrupting device 124 may have a body 126, preferably cylindrical, with ends 128, 130 and an axis C. The cylindrical body 126 may have a through-bore 132 that extends along the axis C between ends 128, 130. A first portion 134 of the body 126 may have a threaded outer surface 136 that extends a distance D₁ from the first end 128. Pipe threads may find use on this surface to couple the cylindrical body 126 with corresponding threads on pipe 106 that attaches to the flanged outlet 114. The pipe 106 may curve or bend to fit space constraints, as desired. In one implementation, the cylindrical body 126 may attach directly to the valve body 110. As noted, this disclosure also contemplates that the silencer 100 may form integrally with the valve body 110, as might occur through use of 3D printing or other suitable construction techniques.

The other end 130 of the body 126 may be configured to dissipate noise. These configurations may include a second portion 138 that incorporates flow-disrupting features 140, which may reside or extend into the flow F of material 104 as it transits the airflow disrupting device 124 from the first end 128 or “inlet” to the second end 130 or “outlet.” In one implementation, the flow-disrupting features 140 may be configured to change properties of flow F, for example, as between properties of an inlet flow F₁ and an outlet flow F₂. These changes may reduce or suppress noise of flow F₂ as it exhausts the outlet 130 to levels that are acceptable and safe for workers in proximity to the device.

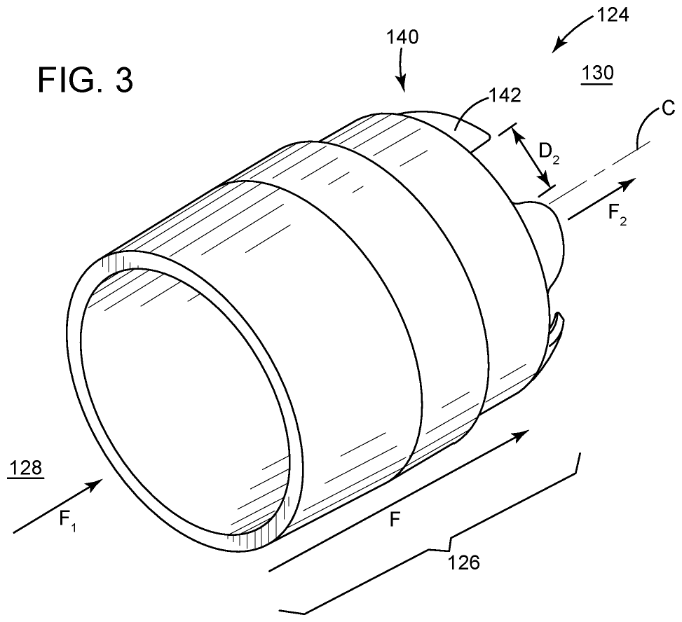

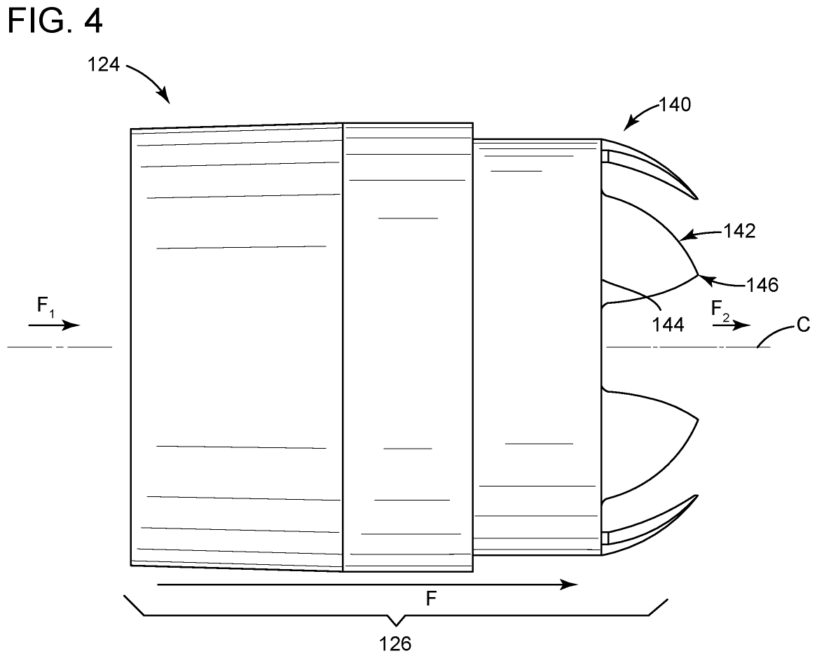

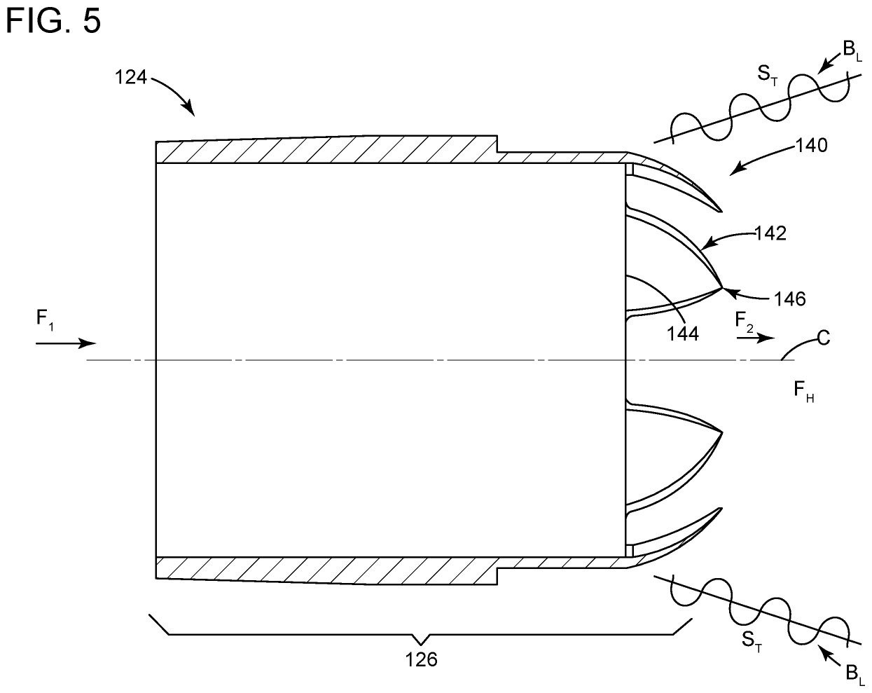

FIGS. 3, 4, and 5 depict exemplary structure for the silencer 100 of FIGS. 1 and 2. The flow-disrupting features 140 may include elements 142 that extend longitudinally away from the outlet 130 of the body 126. The elements 142 may circumscribe the axis C, with adjacent ones spaced circumferentially apart from one another by a distance D₂. The elements 142 may have geometry that effects changes in properties of flow F, for example, to suppress noise as flow F exhausts from the outlet 130 of the airflow disrupting device 124. As best shown in FIGS. 4 and 5, this geometry may embody a chevron or a chevron-shape, although other shapes may prevail as well. The chevrons 142 may have a root 144 that couples with the body 126, for example, forming integrally with the body 126. The chevrons 142 may bend or curl inwardly toward the axis C, terminating at a tip 146 that resides in the flow F₁. This geometry can modify properties that exhaust the device as flow F₂. For example, the geometry may cause flow F₂ to mix in the turbulent boundary layer B_{L} that forms just downstream of the outlet 130. This turbulent boundary layer B_{L} may reduce amplitude of sound waves the high-velocity steam jet F_{H} creates as it exhausts the device because the turbulent boundary layer B_{L} separates the high-velocity steam jet F_{H} from stagnant air S_{T} found downstream of the outlet 130. This feature reduces the pressure gradient typically found across these layers.

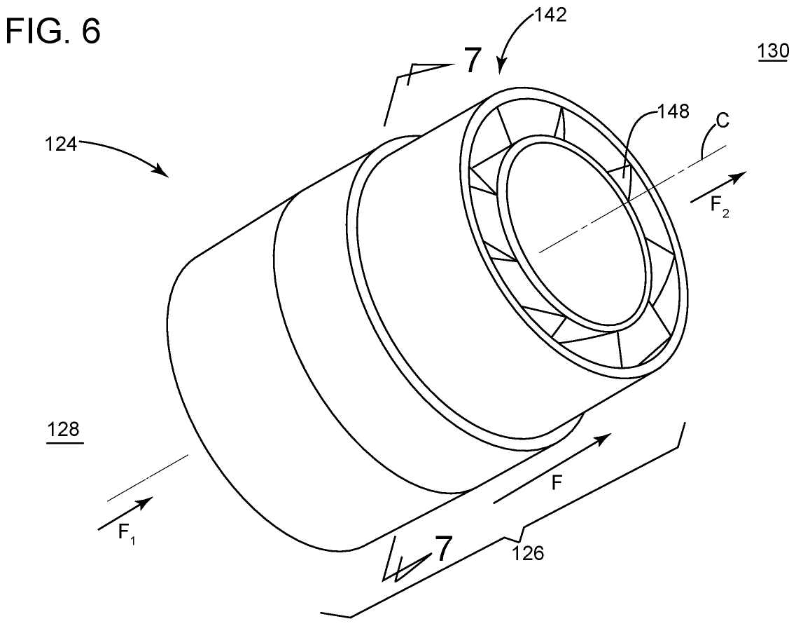

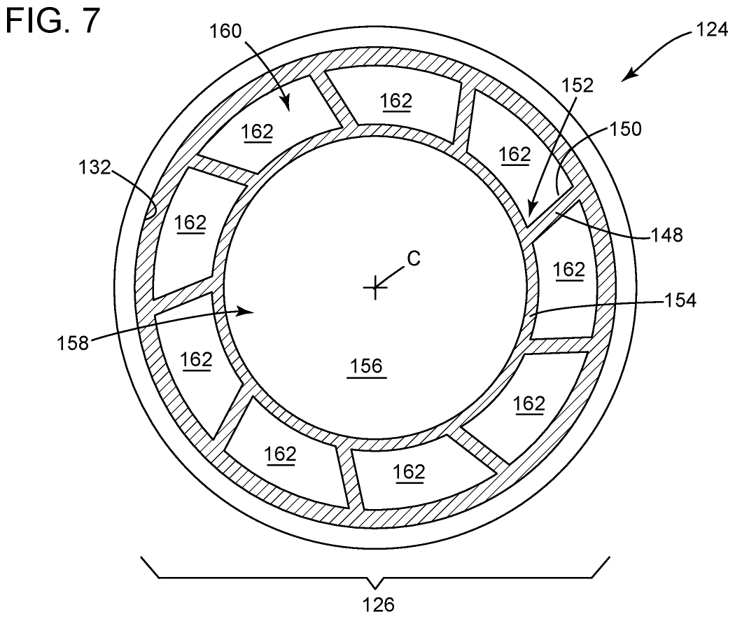

FIGS. 6 and 7 depict other exemplary structure for the silencer 100 of FIGS. 1 and 2. The elements 142 may include blades 148 that circumscribe the axis C inside of the through-bore 132. The blades 148 may have a top 150 and a bottom 152. The top 150 may couple with the body 126. Welds or adhesives may find use for this purpose; however, preference may be given to manufacturing techniques, like additive manufacturing, that can form the blades 148 integrally with the body 126. The blades 148 may extend inwardly (into the through-bore 132) to locate the bottom 152 closer to the axis C. As best shown in the cross-section of FIG. 7, the bottom 152 of the blades 148 may couple with an inner tube 154 that has a central bore 156 that is concentric with the axis C. This structure creates a pair of flow pathways 158, 160. The inner flow pathway 158 follows the central bore 156. On the other hand, the outer flow pathway 160 may include multiple channels 162 that are bound on either side by adjacent blades 148.

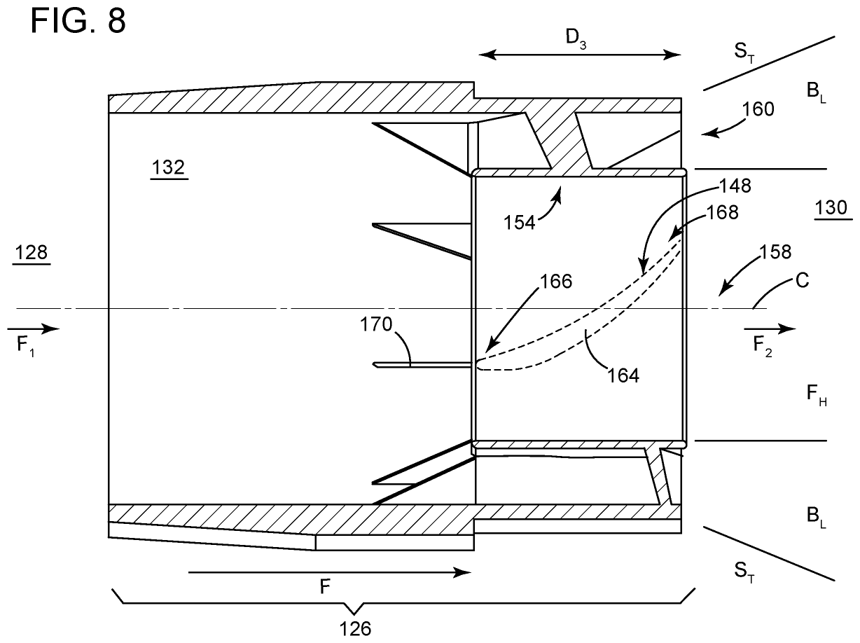

FIG. 8 depicts an elevation view of the cross-section from the side of the structure of FIG. 6. The inner tube 154 may extend a distance D₃ in the through-bore 132. The blades 148 may embody an airfoil 164 with a leading edge 166 and a trailing edge 168. The leading edge 166 may reside at the end of the inner tube 154. The trailing edge 168 may reside at the outlet 130. The design may include baffles 170 that align with the leading edge 166. Construction of the device may form these parts integrally with one another as a single, unitary, or monolithic element. As shown, the airfoil 164 may bend or curve along its length from the leading edge 166 to the trailing edge 168. This geometry can create channels 162, which in turn may direct flow F radially from the upstream side of channels 162 to the downstream side of channels 162 (at outlet 130). In use, a first part of the high-velocity steam jet from the outlet 114 of the valve 108 will exit through the central bore 156 of the inner tube 154. A second part of the high-velocity steam jet will enter channels 162, which will create a swirling outer boundary layer B_{L} (or “turbulent boundary layer B_{L}”) that circumscribes the high-velocity steam jet F_{H}. This swirling outer boundary layer B_{L} may reduce the amplitude of sound waves that the high-velocity steam jet F_{H} (through the inner tube 154) creates because it separates the high-velocity steam jet F_{H} from stagnant air S_{T} found downstream of the outlet 130. This feature reduces the pressure gradient typically found across these layers.

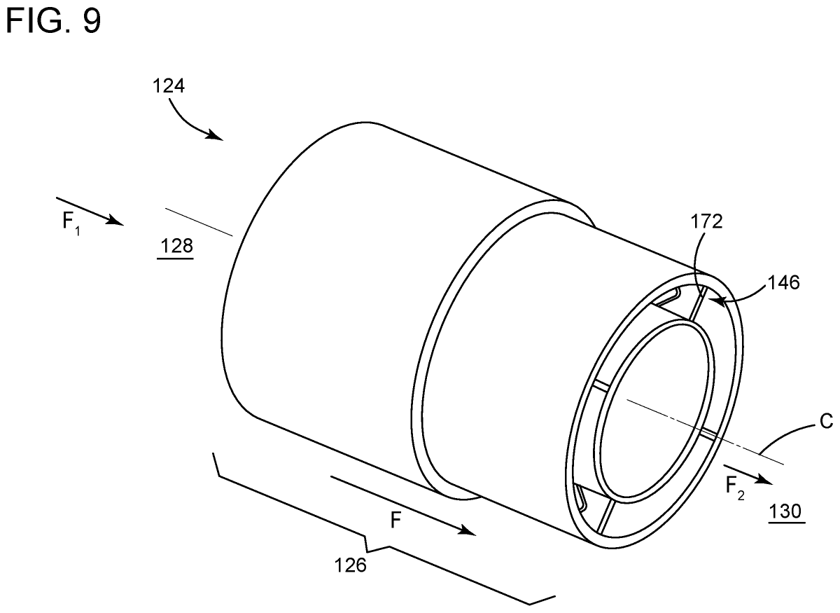

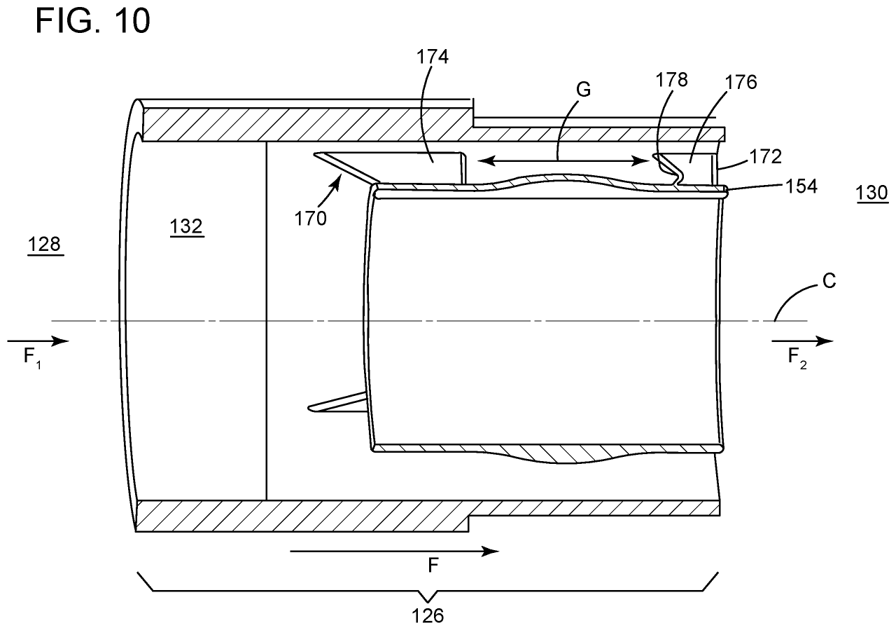

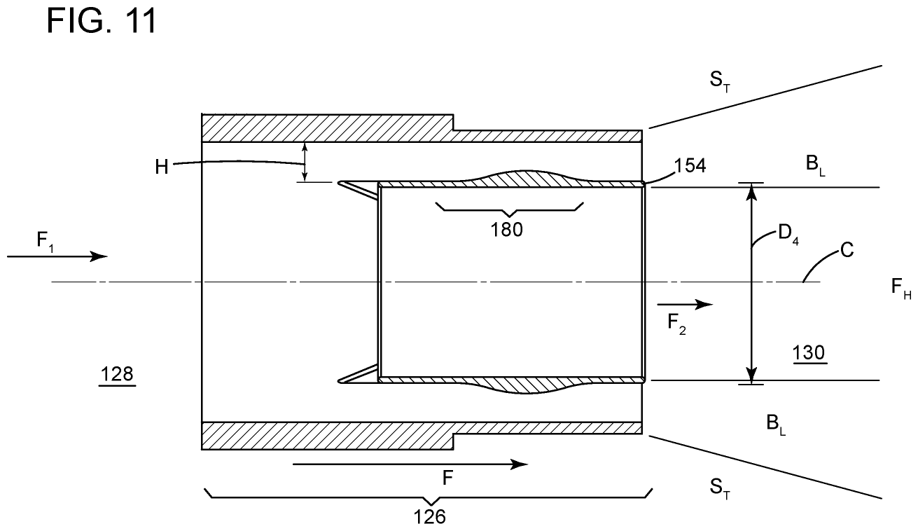

FIGS. 9, 10, and 11 also depict exemplary structure for the silencer 100 of FIGS. 1 and 2. The blades 148 may take the form of a linear or “straight” member 172. This form factor may have a bifurcated or two-part structure, shown here with parts 174, 176 that are spaced apart from one another by a gap G, although this disclosure does contemplate structure for the linear member 172 with more than two parts (or as a single part) as well. The first or proximal part 174 may couple with the baffle 170. The second or distal part 176 may include a groove 178 on its leading or flow-facing edge. As best shown in FIG. 11, the inner tube 154 may include a constricting section 180, for example, a portion in which the outer diameter D₄ of the inner tube 154 varies or changes along the axis C. The constricting section 180 may be configured with values for the outer diameter D₄ that first reduce height H of channels 162 and then increase height H of channels 162 in the direction of flow F along the axis C. This design may find use with high-velocity steam jets that enter the inlet 128 of the device at supersonic flow rates (where F₁>Mach 1). In one implementation, the constricting section 180 may slow flow through the channel 162 to subsonic flow rates prior to exit at the outlet 130 of the device. This subsonic outer boundary layer B_{L} may reduce the amplitude of sound waves that the high-velocity steam jet F_{H} (through the inner tube 154) creates because it creates the boundary layer B_{L} of slower moving material that separates the high-velocity steam jet F_{H} from stagnant air S_{T} found downstream of the outlet 130.

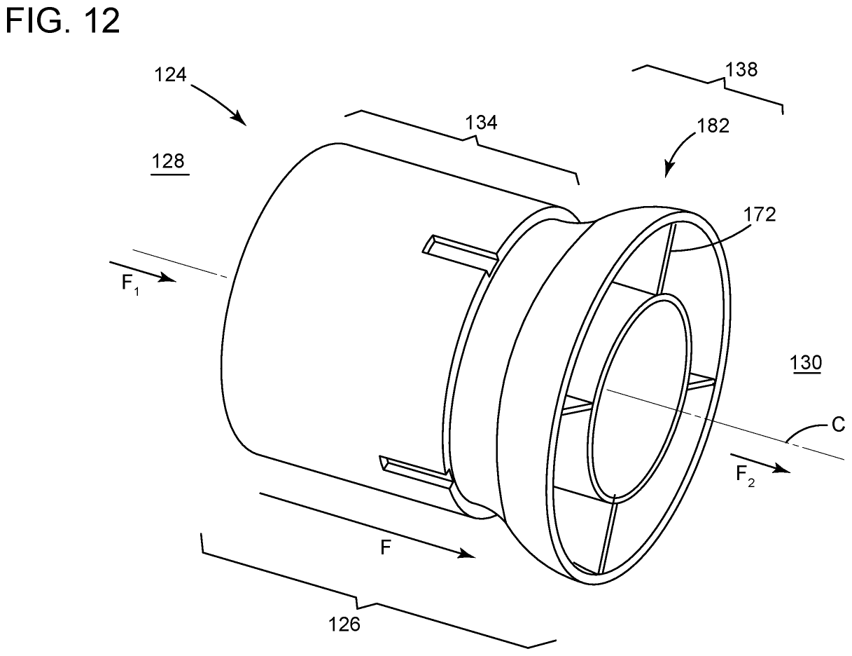

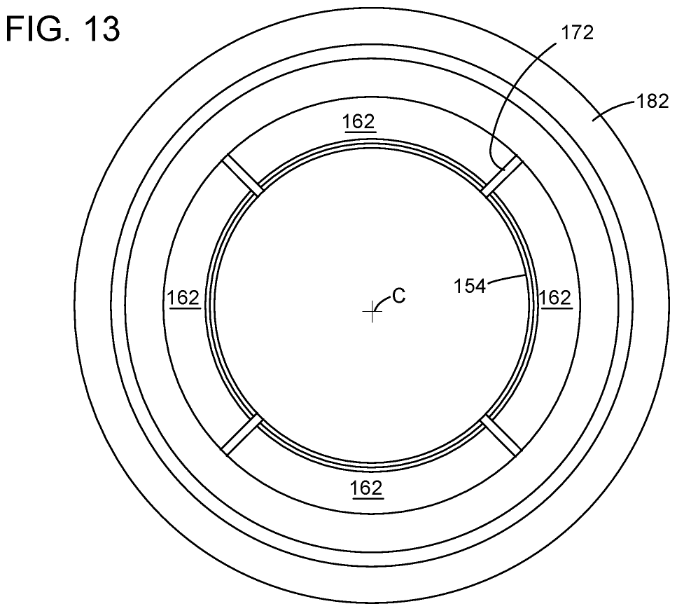

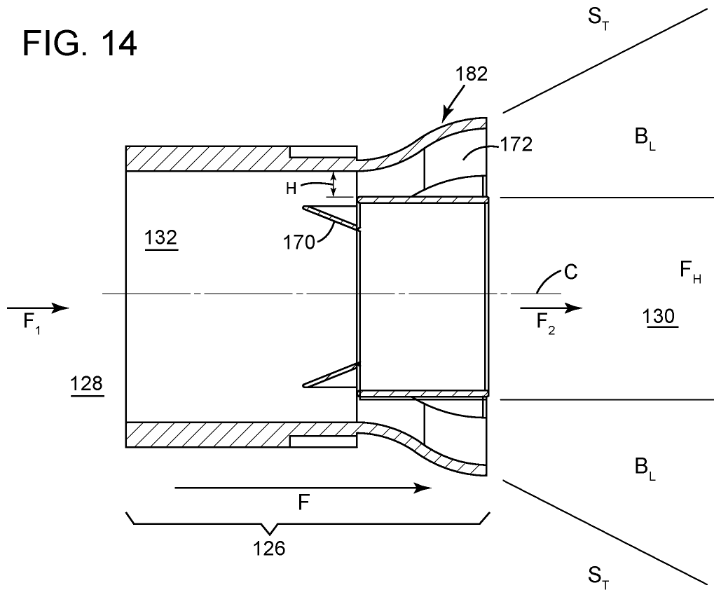

FIGS. 12, 13, and 14 depict another exemplary structure for the silencer 100 of FIGS. 1 and 2. The linear member 172 may embody a single piece that extends along the length of the inner tube 154. The second portion 138 of the body 126 may adopt geometry, like a bell shape 182, that increases in diameter from a first diameter at or proximate the first portion 134 to a second diameter at the outlet 130. This geometry may increase the height H of channels 162 along the axis C. The design may find use with high-velocity steam jets that enter the inlet 128 of the device at subsonic flow rates (wherein F₁<Mach 1). Channels 162 may expand flow of the incoming high-velocity steam jet F₁. The subsonic outer boundary layer B_{L} may reduce the amplitude of sound waves that the high-velocity steam jet F_{H} (through the inner tube 154) creates because the slower-moving boundary layer B_{L} separates the high-velocity steam jet F_{H} from stagnant air S_{T} found downstream of the outlet 130.

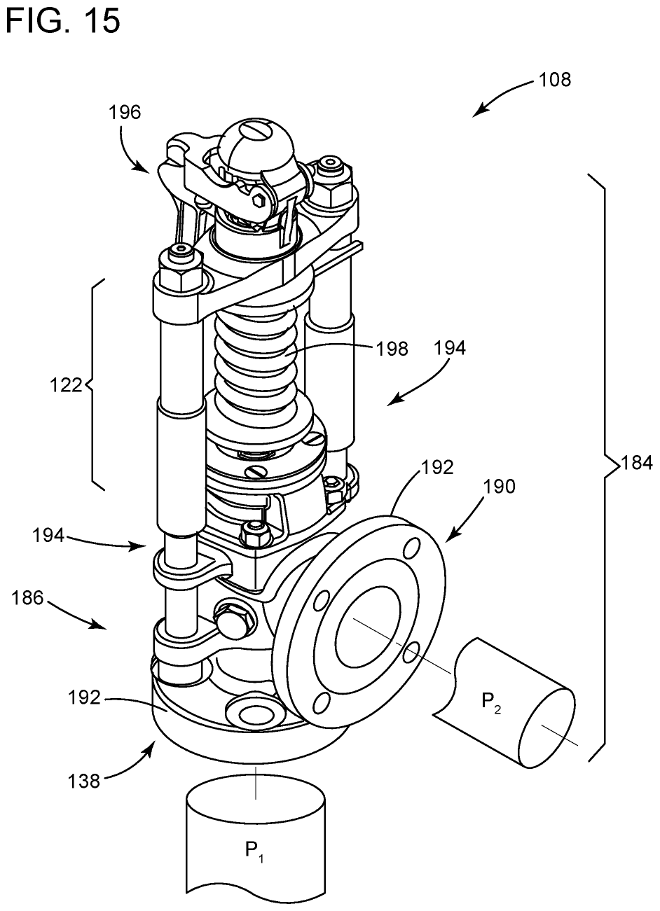

FIG. 15 depicts a perspective view of structure for the safety valve 108 of FIGS. 1 and 2. This structure may include a body 184 that forms a robust, fluid coupling 186 with a pair of openings (e.g., a first opening 188 and a second opening 190). The fluid coupling 186 may be configured to handle pressure of a hot or cold fluid. These configurations may have structure, typically of cast, forged, or machined metal, to form a flow path for fluid to flow between pipes P₁, P₂. Flanges 192 (or other joint connections) at the openings 188, 190 may outfit the fluid coupling 186 to couple to pipes P₁, P₂. Fasteners like bolts may be used to ensure secure connection. The structure may also have a bonnet 192 with structural members 194 that attach to the fluid coupling 186. The structural members 194 may be of various construction. A mechanical actuator 196 may reside on top of the bonnet 192. The mechanical actuator 196 may couple with the preload unit 122 to pre-load a compression spring 198.

Considering the foregoing, operators of power plants and like facilities may benefit from use of the embodiments herein to abate noise from high-velocity steam jets that exit safety valves or other flow controls. The embodiments may fit within pre-existing constraints (like the envelope E) that exist at these facilities and that may foreclose use of other “muffler” designs. As a result, operators may enjoy the benefits of the design, namely noise reduction or noise abatement, without the need to compromise these functions to meet fit requirements of larger, more complex devices.

This specification may include and contemplate other examples that occur to those skilled in the art. These other examples fall within the scope of the claims, for example, if they have structural elements that do not differ from the literal language of the claims, or if they include equivalent structural elements with insubstantial differences from the literal language of the claims.

What is claimed is:

1. A silencer, comprising:
a body having a first end, a second end, and a bore that extends therebetween, the bore having a longitudinal axis, the body comprising:
a first portion configured to attach the first end to a pressure relief valve to receive a flow of fluid into the bore, and
a second portion comprising flow-disrupting features that extend into the flow, the flow-disrupting features configured to change properties of the flow as between an inlet flow at the first end of the body and an outlet flow that exhausts from the bore at the second end of the body.

2. The silencer of claim 1, wherein the flow-disrupting features extend from the second end into the flow.

3. The silencer of claim 1, wherein the flow-disrupting features comprise chevrons disposed about the longitudinal axis.

4. The silencer of claim 1, wherein the flow-disrupting features comprise chevrons disposed about the longitudinal axis, each chevron bending inwardly toward the longitudinal axis.

5. The silencer of claim 1, wherein the flow-disrupting features comprise blades disposed inside of the bore.

6. The silencer of claim 1, wherein the flow-disrupting features comprise blades that circumscribe the longitudinal axis inside of the bore, each blade extending toward the longitudinal axis.

7. The silencer of claim 1, wherein the flow-disrupting features comprise blades with a top and a bottom, the top coupled to the body inside of the bore and the bottom located closer to the longitudinal axis than the top.

8. The silencer of claim 1, further comprising:
an inner tube disposed in the bore and arranged concentrically with the longitudinal axis,
wherein the flow-disrupting features comprise blades that attach at a first end to the body, inside the bore, and at a second end to the tube.

9. The silencer of claim 1, further comprising:
an inner tube disposed in the bore and arranged concentrically with the longitudinal axis, and
baffles disposed on one end of the tube,
wherein the flow-disrupting features comprise blades inside the bore that attach at a first end to the body and at a second end to the tube, and
wherein the baffles align with the blades.

10. The silencer of claim 1, further comprising:
an inner tube disposed in the bore and arranged concentrically with the longitudinal axis,
wherein the flow-disrupting features comprise airfoils that form channels between the body and the inner tube.

11. The silencer of claim 1, further comprising:
an inner tube disposed in the bore and arranged concentrically with the longitudinal axis, the inner tube having an outer diameter that varies along the longitudinal axis.

12. The silencer of claim 1, further comprising:
an inner tube disposed in the bore and arranged concentrically with the longitudinal axis, the inner tube having an outer diameter that varies along the longitudinal axis to form a constricting section with the body,
wherein the flow-disrupting features comprise blades that extend along the length of the inner tube and have a first part and a second part, one each disposed on either side of the constricting section.

13. The silencer of claim 1, wherein the body forms a bell shape on the second end, and wherein the flow-disrupting features comprise blades that extend along the length of the inner tube.

14. The silencer of claim 1, further comprising:
an inner tube disposed in the bore and arranged concentrically with the longitudinal axis,
wherein the body forms a bell shape about the inner tube, and
wherein the flow-disrupting features comprise blades that extend along the length of the inner tube.

15. A pressure relief valve, comprising:
a valve body with an inlet and an outlet;
a silencer coupled with the outlet, the silencer comprising,
a body with a bore that forms first opening, a second opening, and a longitudinal axis extending therebetween, and
a flow-disrupting device coupled to the body,
wherein the flow-disrupting device is configured to change properties of flow so as to reduce noise as between a first flow that exits the outlet of the valve body into the first opening of the bore and a second flow that exits the second opening of the bore.

16. The pressure relief valve of claim 15, wherein the flow-disrupting device comprises blades that extend into the bore.

17. The pressure relief valve of claim 15, wherein the flow-disrupting device comprises airfoils that extend into the bore.

18. The pressure relief valve of claim 15, wherein the flow-disrupting device comprises an inner tube disposed in the bore and concentric with the longitudinal axis.

19. The pressure relief valve of claim 15, wherein the flow-disrupting device comprises an inner tube disposed in the bore and concentric with the longitudinal axis, and wherein the inner tube has an outer diameter that varies to form a constricting section with the body.

20. The pressure relief valve of claim 15, wherein the flow-disrupting device comprises an inner tube disposed in the bore and concentric with the longitudinal axis, and wherein the body forms a bell shape around the inner tube.
